(19) United States
(12) Patent Application Publication
(10) Pub. No.: US 2002/0168907 A1
(43) Pub. Date: Nov. 14, 2002

(54) Polyurethane/geotextile composite and a process related thereto for the production thereof

(76) Inventors: Peter H. Markusch, McMurray, PA (US); Ralf Guether, Pittsburgh, PA (US)

Correspondence Address: BAYER CORPORATION, PATENT DEPARTMENT, 100 BAYER ROAD, PITTSBURGH, PA, 15205, US

(21) Appl. No.: 09/809,604

(22) Filed: Mar. 15, 2001

(51) Int. Cl. C08L 1/00

(52) U.S. Cl. 442/86

(57) ABSTRACT

A polyurethane/geotextile composite having greater strength and dimensional stability than composites made with filled polyurethanes is produced by impregnating a geotextile with an unfilled polyurethane composition and allowing the polyurethane composition to cure. The polyurethane composition employed is reaction product of a liquid polyisocyanate having an isocyanate content of at least 10% by weight, a high molecular weight polyether polyol, and an organometallic catalyst. A low molecular weight diol or triol may optionally be included in the polyurethane-forming reaction mixture. These polyurethane/geotextile composites are particularly suitable for lining ditches and canals.

### TECHNICAL FIELD OF THE INVENTION

The present invention relates to an improved polyurethane geotextile composite prepared with an unfilled polyurethane composition. The invention further relates to a process of forming a polyurethane geotextile composite using an unfilled polyurethane composition.

### BACKGROUND OF THE INVENTION

In recent years, the management of natural resources has become important in many countries throughout the world. Efforts have been directed both toward the conservation of our resources and toward the elimination of pollution from our environment. Particular emphasis has been placed on waste leakage and water loss.

Losses in the distribution of water using unlined irrigation ditches are estimated at a minimum to be 25% and in some situations to be more than 50% depending upon the porosity of the ditch surface and the distance the water is being moved. In most rural areas, ditches are formed by excavating the soil to the desired depth and width. The water moves through the ditch in contact with the exposed natural surface. This can be sand, clay, rocks, etc. and, more commonly, mixtures thereof. The porosity will depend upon the proportions of the different components.

The loss of water in unlined irrigation ditches at one time was considered acceptable only because the supply of water exceeded demand. However, as civilization has developed and world population has increased, more water is required for both greater food production and for the markedly by increasing non-agriculture uses. In addition to greater domestic uses in sanitation, industry now employs large quantities of water in manufacturing and processing procedures.

This high level of consumption plus the very high cost of developing new water supplies has shifted attention to water conservation. Domestic appliances that use less water have been developed. Also, industry has installed recycling purification systems to reduce water consumption.

Although conservation efforts have reduced water consumption to a degree, water is still in relatively short supply, particularly in recent years with the severe droughts in the United States and other countries. Since the most cost effective conservation opportunities and readily accessible water supplies already have been developed, greater attention must be directed to improving the efficiency of water distribution systems.

Improvements in water distribution have been made. A limited number of ditches and canals have been lined with concrete and/or preformed concrete pipes. Concrete is durable and has a long life when properly used. However, concrete is expensive to place and finish and is damaged by unfavorable temperatures during curing. Also, concrete is subject to frost damage, cracking and heaving which results in leaks.

Processes for forming polyurethane composite liners for canals and ditches and apparatus to perform such processes are disclosed, for example, in U.S. Pat. Nos. 4,872,784; 4,955,759; 4,955,760; 5,049,006; 5,062,740; 5,421,677; and 5,607,998.

U.S. Pat. No. 5,421,677 (“the '677 patent”) is directed to an improved process of forming a ditch liner. The mixture of the '677 patent includes one or more fillers in an amount of up to 60% by weight based upon the total weight of the mixture. The mixture is dispensed on a geotextile, thereby forming a liquid filler-containing polyurethane soaked geotextile composite. The liquid polyurethane soaked geotextile composite is then placed over the surface of an area to be lined. One drawback of the mixture taught by the '677 patent is that the filler in the mixture does not completely dry, especially when stored and used in an outdoor application. The water in the filler reacts with the polyisocyanate and causes the mixture to foam. Foaming weakens the strength and impermeability of the composite.

For the foregoing reasons, it would be desirable to develop an improved polyurethane composition for producing a polyurethane geotextile composite, specifically, a polyurethane composition that does not include a filler.

### SUMMARY OF THE INVENTION

The invention is directed to an improved geotextile composite useful as a liner for canals and ditches and to a process for making a canal or ditch liner with such composite. The composite is made up of a geotextile impregnated with an unfilled polyurethane composition, the unfilled polyurethane composition comprising a reaction product of:

a) a liquid polyisocyanate having an isocyanate content of at least 10% by weight,

b) an isocyanate reactive component comprising one or more polyether polyols having from 2 to 6 hydroxyl groups and a number average molecular weight of at least 250 to 8,000 and 0 to 10% by weight, based on total weight of b), of a low molecular weight diol or triol having an equivalent weight of 31 to 99, and

c) an organometallic catalyst.

The invention is further directed to a canal or ditch lined with the improved polyurethane geotextile composite.

### BRIEF DESCRIPTION OF THE DRAWINGS

FIG. 1 shows the surface of the polyurethane casting produced in Example 1 as seen with a scanning electron microscope.

FIG. 2 shows the surface of the polyurethane casting produced in Example 2 as seen with a scanning electron microscope.

FIG. 3 shows the surface of the polyurethane casting produced in Example 3 as seen with a scanning electron microscope.

### DETAILED DESCRIPTION OF THE INVENTION

The present invention is directed to an improved polyurethane/geotextile composite prepared with an unfilled polyurethane composition, the process for producing such composite and to a ditch or canal lined with such composite.

The improved geotextile composite liner which is suitable for canals and ditches is a geotextile impregnated with an unfilled polyurethane composition, the unfilled polyurethane composition comprising a reaction product of:

a) a liquid polyisocyanate having an isocyanate content of at least 10% by weight, preferably at least 20% by weight, most preferably, at least 30% by weight,

b) an isocyanate reactive composite comprising one or more high molecular weight polyether polyols having from 2 to 6 hydroxyl groups and a number average molecular weight of at least 250 to 8,000 and from 0 to 10% by weight, based on total weight of b), of a low molecular weight diol or triol having an equivalent weight of 31 to 99, and

c) an organometallic catalyst, preferably in an amount of up to 0.5 parts by weight per hundred parts by weight of component b), more preferably from 0.0001 to 0.05 parts by weight catalyst per 100 parts by weight of component b).

As used herein, the term “unfilled polyurethane composition” means a polyurethane produced from a reaction mixture which does not include any filler materials.

A canal or ditch is lined with the improved polyurethane geotextile composite by impregnating a geotextile with an unfilled polyurethane composition, laying the polyurethane-impregnated geotextile onto a surface of a canal or ditch before the polyurethane composition has fully cured, conforming the polyurethane-impregnated geotextile to the shape of the surface of the canal or ditch, and allowing the polyurethane composite to fully cure to form a leakproof liner.

In a preferred embodiment of the invention, the geotextile is impregnated with an unfilled polyurethane composition which is a reaction product of

a) a liquid polyisocyanate having an isocyanate content of at least 10% by weight,

b) a polyol mixture comprising:

i) from 5 to 15 parts by weight of a propylene oxide adduct of an amine containing starting component, having a molecular weight of from 250 to 1000, preferably from 400 to 600,

ii) a propylene oxide adduct of a low molecular weight organic compound having from 3 to 6 OH groups (preferably having 3 or 4 OH groups), and having a molecular weight of from 250 up to 1000, preferably from 600 to 800, and

iii) a propylene oxide adduct of a low molecular weight diol having a molecular weight of from 250 up to 3000, and

c) a tin catalyst.

The above-described composition used in the preferred embodiment of the invention cures in a reasonable amount of time without application of any externally applied heat and under temperature conditions varying from 0° C. to 50° C. It is, of course, possible to accelerate the curing of the polyurethane by any of the techniques known to those in the art but such acceleration is not necessary.

The various materials used in the composition of the present invention are known in the art. The polyurethane-forming composition of the present invention requires a) a liquid isocyanate having an isocyanate content of at least 10% by weight, b) at least one polyether polyol, and c) a catalyst.

As used herein, the term “geotextile” refers to any woven or non-woven porous blanket or mat which is produced from natural or synthetic fibers. Also, as used herein, the term “ditch” and “canal” are used interchangeably and can refer to any liquid-carrying surface having a depression or sloped side. Geotextiles are used primarily to line earthen surfaces. Such liners may have secondary uses in lining roofs, ponds, reservoirs, landfills, and underground storage tanks, canals or ditches. Examples of geotextiles include woven or non-woven polypropylene, polyester, jute and cotton fabrics.

The isocyanates useful herein are known. Suitable organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Such isocyanates include those represented by the formula Q(NCO)ₙ in which n represents a number from 2 to about 5 (preferably 2 to 3) and Q represents an aliphatic hydrocarbon group containing from 2 to about 18 (preferably 6 to 10) carbon atoms, a cycloaliphatic hydrocarbon group containing from 4 to about 15 (preferably 5 to 10) carbon atoms, an araliphatic hydrocarbon group containing from 8 to 15 (preferably 8 to 13) carbon atoms, or an aromatic hydrocarbon group containing from 6 to about 15 (preferably 6 to 13) carbon atoms. Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3-and 1,4-diisocyanate, and mixtures of these isomers; 1-isocyanato-3,3,5-trimethyl-5-isocyanatomethylcyclohexane (“isophorone diisocyanate”; See, e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (“hydrogenated MDI”, or “HMDI”); 1,3- and 1,4-phenylene diisocyanate; 2,4- and 2,6-toluene diisocyanate and mixtures of these isomers (“TDI”); diphenylmethane-2,4′- and/or -4,4′-diisocyanate (“MDI”); naphthylene-1,5-diisocyanate; triphenylmethane-4,4′,4″-trisocyanate; polymethylene poly(phenyl-isocyanates) of the type which may be obtained by condensing aniline with formaldehyde, followed by phosgenation (“crude MDI”), which are described, for example, in British Patents 878,430 and 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in British Patent 994,890, Belgian Patent 761,616, and published Dutch Patent Application 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in British Patent 889,050; polyisocyanates obtained by telomerization reactions of the type described, for example, in U.S. Pat. No. 3,654,106; polyisocyanates containing ester groups of the type described, for example, in British Patents 965,474 and 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. It is also possible to use mixtures of the polyisocyanates described above.

In general, it is preferred to use readily available polyisocyanates, such as 2,4- and 2,6-toluene diisocyanates and mixtures of these isomers (“TDI”); polymethylene (polyphenylisocyanates) of the type obtained by condensing aniline with formaldehyde, followed by phosgenation (“crude MDI”); and polyisocyanates containing carbodiimide groups, urethane groups, allophanate groups, isocyanurate groups, urea groups, or biuret groups (“modified polyisocyanates”). The commercially available phosgenation products of aniline/formaldehyde condensates are the most preferred isocyanates to be used in the present invention.

The liquid polyisocyanates useful in the present invention have an isocyanate group content of at least 10% by weight, preferably more than 20% by weight and most preferably more than 30% by weight. Aromatic polyisocyanates are preferred. Particularly preferred polyisocyanates are liquid polymethylene poly(phenylisocyanates) having an NCO content of from about 30 to about 33% and a viscosity of from about 20 to 2,000 mPa·s at 25° C.

Suitable polyether polyols for use in component b) include polyethers prepared, for example, by the polymerization of epoxides such as ethylene oxide, propylene oxide, butylene oxide, tetrahydrofuran, styrene oxide, or epichlorohydrin, optionally in the presence of Lewis acids such as BF₃, or prepared by chemical addition of such epoxides, optionally added as mixtures or in sequence, to starting components containing reactive hydrogen atoms, such as water, alcohols, or amines. Examples of starting components include ethylene glycol, 1,3- or 1,2-propanediol, 1,2-, 1,3-, or 1,4-butanediol, trimethylolpropane, 4,4′-dihydroxydiphenylpropane, aniline, ammonia, ethanolamine, and ethylene diamine. Sucrose polyethers of the type described, for example, in German Offenlegungsschriften 1,176,358 and 1,064,938 may also be used. Polyethers which contain predominantly primary hydroxyl groups (up to about 90% by weight, based on all of the hydroxyl groups in the polyether) are also suitable. Polyethers modified by vinyl polymers of the kind obtained, for example, by the polymerization of styrene and acrylonitrile in the presence of polyethers (e.g., U.S. Pat. Nos. 3,383,351, 3,304,273, 3,523,093, and 3,110,695 and German Patent 1,152,536) are also suitable, as are polybutadienes containing hydroxyl groups. Particularly preferred polyether polyols include polyoxyalkylene polyether polyols, such as polyoxyethylene diol, polyoxypropylene diol, polyoxybutylene diol, and polytetramethylene diol, as well as polyoxypropylene polyoxyethylene triols.

Other suitable polyether polyols for use as component b) include the so-called “PHD polyols”, which are prepared by reaction of an organic polyisocyanate, hydrazine, and a polyether polyol. U.S. Pat. No. 3,325,421 discloses a method for producing suitable PHD polyols by reacting a stoichiometric or substoichiometric quantity (relative to diamine) of polyisocyanate dissolved in a polyol having a molecular weight of at least 500 and a hydroxyl number of no more than 225. See also U.S. Pat. Nos. 4,042,537 and 4,089,835.

Suitable polyether polyols for use as component b) also include the so-called “polymer polyols”, which are prepared by polymerizing styrene and acrylonitrile in the presence of a polyether. See, for example, U.S. Pat. Nos. 3,383,351, 3,304,273, 3,523,093, 3,652,639, 3,823,201 and 4,390,645. Particularly preferred polyols are polyoxypropylene polyethers having a number average molecular weight of from about 400 to about 4,000 and an average hydroxy functionality of from 2 to 3.

The most preferred polyethers are polyoxypropylene polyethers that do not contain ethylene oxide units.

It is also preferred that isocyanate reactive component b) contain no more than 0.5% by weight water, most preferably no more than 0.1% by weight water prior to reaction with the polyisocyanate.

The most preferred polyol component b) is a mixture of three components: (1) a propylene oxide adduct of an amine containing starting component which adduct has a molecular weight of from about 250 to about 1000 (preferably from about 400 to about 600), (2) a propylene oxide adduct of a low molecular weight organic compound which adduct has from 3 to 6 OH groups and a molecular weight of from about 250 to 1000 (preferably from 600 to 800), and (3) a propylene oxide adduct of a low molecular weight diol which adduct has a molecular weight of from about 250 to 3000 (preferably from 1500 to 2500). This mixture generally contains from 5 to 15 parts by weight of the amine-initiated adduct (1). The amounts of adducts (2) and (3) are such that the average OH functionality of these adducts is more than 2 but less than 2.8.

Up to 10% by weight, based on total isocyanate-reactive component b), of a low molecular weight (number average molecular weight less than 250) diol or triol having an equivalent weight of from 31 to 99 may optionally be included in the isocyanate reactive component. However, it is preferred, that no such low molecular weight diol or triol be included.

The polyurethane-forming reaction mixture also contains a catalyst c) for catalyzing the reaction between isocyanate groups and hydroxyl groups (i.e., a urethane catalyst). Such catalysts are known in the art. Suitable catalysts are organometallic compounds, preferably organic tin compounds. Organic tin(II) salts of carboxylic acids such as tin(II) acetate, tin(II) octoate, tin(II) ethyl hexoate and tin(II) laurate and tin(IV) compounds such as dibutyl tin oxide, dibutyl tin dichloride, dibutyl tin diacetate, dibutyl tin dilaurate, dibutyl tin maleate, dioctyl tin diacetate and the like are particularly useful. The catalyst is generally used in an amount of from about 0.0001 to about 0.05 parts by weight per 100 parts by weight of isocyanate-reactive component b).

The polyurethane-forming reaction mixture should not contain a catalyst which would catalyze the reaction between an isocyanate group and water. The relative amounts of the liquid polyisocyanate component and isocyanate-reactive component used to produce the unfilled polyurethane composition are such that the NCO/OH equivalent ratio is from 1.4:1 to 0.9 to 1.0, preferably from 1.1:1.0 to 1.0:1.0.

The improved polyurethane composition of the present invention can be applied to one or more geotextiles for lining a ditch and/or canal. As used herein, the term “geotextile” refers to any woven or non-woven porous blanket or mat which is produced from natural or synthetic fibers.

In one embodiment of the present invention, the ditch and/or canal is lined using a machine such as that described in U.S. Pat. No. 5,639,331 (“the '331 patent”). The '331 patent teaches a mobile ditch lining apparatus comprising reservoirs for supplying raw materials such as resin, catalysts, colors or other additives. The reservoirs are connected to a mixing chamber through flexible conduit means. The delivery rate of the raw materials to the mixing chamber varies depending upon the particular formulation and quantity thereof required for a specific incremental area of the liner being formed. The components used to produce the unfilled polyurethane composition employed in the present invention are mixed in the mixing chamber.

From the mixing chamber, the unfilled polyurethane composition is applied to one or more geotextiles. The geotextile is pulled from a vat containing the unfilled polyurethane composition through an adjustable die. The opening of the die provides even distribution of the polyurethane reaction mixture on the geotextile, determines how much polyurethane is dispensed on the geotextile, and also controls the thickness of the polyurethane-soaked geotextile composite. The polyurethane-soaked geotextile is then cut to the desired length and placed in the canal or ditch where it conforms to the surface and cures to form a polyurethane geotextile composite liner. Installing the polyurethane soaked or impregnated geotextile liner should be done in such a way that the end of one piece or section of the geotextile overlaps to a certain extent the end of the adjacent piece or section of geotextile to assure that after curing a seamless permanent flexible polyurethane composite liner is obtained.

In another embodiment of the present invention, the unfilled polyurethane composition is applied to the geotextile by spraying using commercially available two-component polyurethane spray equipment. The polyurethane impregnated geotextile is subsequently placed in the ditch or canal to be lined where it conforms to the surface and cures to form a polyurethane geotextile composite. The geotextile can also first be cut to size and placed in the canal or ditch before the unfilled polyurethane composition is sprayed onto it. Preferably, the geotextile impregnated with the polyurethane is rolled, e.g., with a paint roller, to allow the polyurethane to penetrate through the geotextile to the surface of the ditch or canal while the polyurethane is still liquid. It is also feasible to first spray the unfilled polyurethane onto one geotextile and then apply another geotextile over the first polyurethane impregnated geotextile.

In another embodiment of the invention, the unfilled polyurethane composition is first sprayed on the concrete (even if cracked or broken) of a concrete lined ditch and subsequently a geotextile is placed over the sprayed concrete so that the geotextile will absorb the still liquid polyurethane which will subsequently cure to form a solid yet flexible polyurethane/geotextile composite.

State of the art sprayable polyurethane formulations are not useful in the present invention because they exhibit gel times of only several seconds. In order to prepare the polyurethane geotextile composites of the present invention, using an unfilled polyurethane composition, gel times of at least five minutes, preferably more than 10 minutes are required.

If additional layers of polyurethane composite are desirable, any of the above-described application processes can be repeated one or more times.

The thickness of the polyurethane geotextile composite can be varied over a wide range but usually measures from about 50 microns to about 500 microns.

The amount of polyurethane applied to the geotextile(s) can be varied but usually the polyurethane applied per square meter of geotextile ranges from 1 kg to 20 kg, preferably from 2 kg to 5 kg.

If desirable, several layers of the polyurethane impregnated geotextile(s) may be applied over each other to obtain a composite of higher strength and dimensional stability. This is actually the preferred mode for lining an earthen canal or ditch

The invention is further illustrated but is not intended to be limited by the following Examples in which all parts and percentages are by weight, unless otherwise specified.

### EXAMPLES

The following materials were used in the Examples.

| | |
|---|---|
| Isocyanate A: | polymethylene poly (phenylisocyanate) having an |
| | NCO content of about 31.5%, a functionality of 2.6 |
| | and a viscosity at 25° C. of 200 mPa · s. |
| Polyol 1: | a monoethanolamine-started propylene oxide |
| | polyether polyol, having an OH number of about 350, |
| | a functionality of about 3 and a number average |
| | molecular weight of about 480. |
| Polyol 2: | a glycerine-started propylene oxide polyether polyol, |
| | having an OH number of about 250, a functionality of |
| | about 3 and a number average molecular weight of |
| | about 670. |
| Polyol 3: | a propylene glycol-started propylene oxide having an |
| | OH number of 56, a functionality of about 2 and a |
| | number average molecular weight of about 2000. |
| Catalyst A: | Dimethyltin dilaurate, commercially available as |
| | Fomrez UL-28 from Witco. |

The following polyol blend was used in the Examples:

| | |
|---|---|
| Polyol Blend A: | 10 pbw Polyol 1 |
| | 45 pbw Polyol 2 |
| | 45 pbw Polyol 3 |
| | 0.01 pbw Catalyst A |

The polyurethane castings of Examples 1 and 2 were prepared by the following procedure. The procedure for Example 3 was identical, with the exception that no filler (i.e., rubber crumbs) was mixed with Polyol Blend A or otherwise included in the polyurethane composition.

60 g of rubber crumbs were thoroughly mixed with 140 g of Polyol Blend A. 61.1 g of Isocyanate A were then added and the reaction mixture was hand mixed at 25-30° C. for about 2 minutes. The mixture was then poured into a mold (6 in.×6 in.×0.125 in.) at room temperature, and the samples were allowed to cure at room temperature for 16 hours before demolding. The samples were stored for at least 1 week at room temperature in a temperature and humidity controlled environment and then tested for various physical and mechanical properties. The results are shown in the Table. The rubber crumbs used in Example 1 were stored at ambient temperature under humid conditions (humidity>80%) for 16 hours. The rubber crumbs used in Example 2 were thoroughly dried in an oven at 110° C. for 16 hours before use.

TABLE

| | Example 1 | Example 2 | Example 3 |
|---|---|---|---|
| Polyol Blend A (grams) | 140 | 140 | 140 |
| Isocyanate A (grams) | 61.1 | 61.1 | 61.1 |
| Rubber crumbs (grams) | 60 | 60 | — |
| Isocyanate Index | 105 | 105 | 105 |
| Tensile Strength (psi) | 194.3 | 1235.7 | 1479 |
| Elongation (%) | 59.2 | 63.1 | 75.2 |
| Split Tear (pli) | 8.7 | 38.4 | 43 |
| Die “C” Tear | 34 | 145.9 | 155 |
| Water Vapor Transmission | 0.2 | 0.05 | 0.08 |

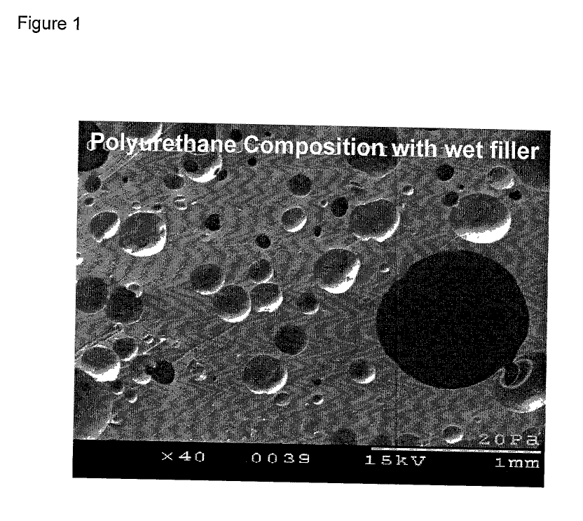

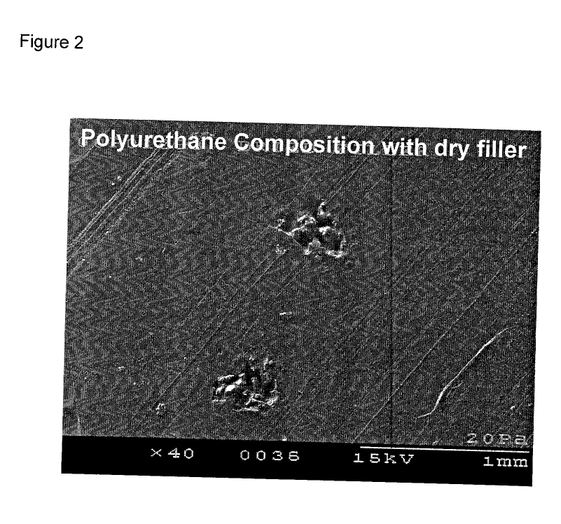

The unfilled polyurethane composition within the scope of the present invention (Example 3), had superior properties when compared to the filled systems illustrated in Examples 1 and 2. The wet rubber crumbs used in Example 1 caused severe foaming and also led to a loss in physical properties of the resulting polyurethane. FIG. 1 shows the micro-bubbles formed by the reaction of the isocyanate with the water present in the rubber crumbs used. The filled polyurethane made with the dry filler in Example 2 did not exhibit the severe foaming of the composition of Example 1, however, micro-defects caused by the rubber particles which can be seen in FIG. 2, cause a weakening of the polyurethane. Under actual application conditions outdoors it is not feasible to dry the filler or to keep a pre-dried filler from absorbing moisture on the surface. Predrying the filler for an extended period of time at high temperatures also has a negative impact on the economics of the composite liner system.

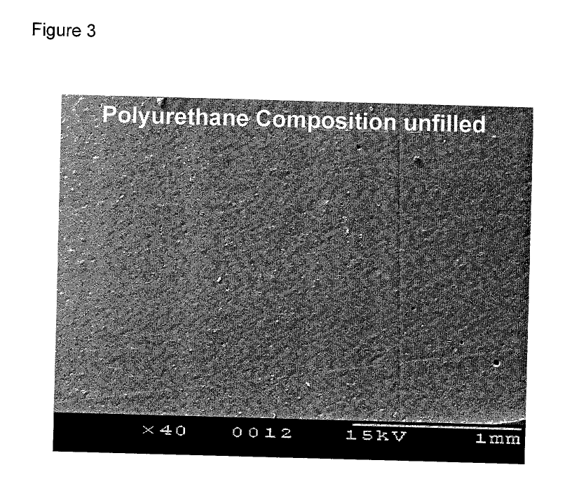

The foaming and micro-defects in the polyurethanes of Examples 1 and 2 seen in FIGS. 1 and 2, are not, however, experienced in the unfilled polyurethane made in Example 3 as is evident from FIG. 3.

### Example 4

Isocyanate A, and Polyol Blend A were delivered to a mixing chamber at an Isocyanate Index of 105 and applied to a geotextile using the device disclosed in U.S. Pat. No. 5,639,331. The impregnated geotextile was then cut to the desired length and placed in an earthen ditch in a manner such that the impregnated geotextile covered the entire surface area of the ditch but did not overlap the “lip” or “edge” of the ditch. Any wrinkles or irregularities were smoothed before the polyurethane cured. The polyurethane was allowed to cure under ambient conditions. The ditch liner thus formed was very effective in conveying captured rain water without significant loss due to seepage or leakage.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An improved polyurethane/geotextile composite which is useful as a liner for canals and ditches comprising a geotextile impregnated with an unfilled polyurethane composition comprising a reaction product of:
a) a liquid polyisocyanate having an isocyanate content of at least 10% by weight,
b) an isocyanate reactive component comprising one or more high molecular weight polyether polyols having from 2 to 6 hydroxyl groups and a number average molecular weight of at least 250 to 8,000 and 0 to 10% by weight of a low molecular weight diol or triol having an equivalent weight of 31 to 99, and
c) an organometallic catalyst.

2. The composite of claim 1, wherein the isocyanate reactive component b) contains no more than 0.1% by weight water prior to reaction with the liquid polyisocyanate a).

3. The composite of claim 1, wherein the amounts of component a) and b) are such that the NCO: OH equivalent ratio is from 1.4:1.0 to 0.9:1.0.

4. The composite of claim 1, wherein the amounts of component a) and b) are such that the NCO: OH equivalent ratio is from 1.1:1.0 to 1.0:1.0.

5. The composite of claim 1, wherein the liquid polyisocyanate has an isocyanate group content of more than 20% by weight.

6. The composite of claim 1, wherein the liquid polyisocyanate has an isocyanate group content of more than 30% by weight.

7. The composite of claim 1, wherein the polyether polyol comprises one or more polyoxypropylene polyethers having a molecular weight of 400 to 4,000 and an average functionality of 2 to 3.

8. The composite of claim 1, wherein the catalyst comprises a tin compound in the amount of from 0.0001 to 0.05 parts by weight per 100 parts by weight of isocyanate reactive component.

9. The composite of claim 1, wherein the liquid polyisocyanate is an aromatic polyisocyanate.

10. The composite of claim 1, wherein the liquid poly-isocyanate is a polymethylene poly(phenylisocyanate) having an NCO-content of about 30 to 33% and a viscosity of from about 20 mPa·s to 2,000 mPa·s at 25° C.

11. The composite of claim 1, wherein the isocyanate reactive component b) does not include a low molecular weight diol or triol.

12. The composite of claim 1, wherein the amount of polyurethane per square meter of geotextile ranges from 1 kg to 20 kg.

13. The composite of claim 1, wherein the amount of polyurethane per square meter of geotextile ranges from 2 kg to 5 kg.

14. The composite of claim 1, wherein the thickness of the polyurethane geotextile composite ranges from 50 microns to about 500 microns.

15. A process for producing an improved polyurethane geotextile composite useful as a liner for canals and ditches comprising (1) impregnating a geotextile with an unfilled polyurethane composition, the unfilled polyurethane composition comprising the reaction product of:
a) a liquid polyisocyanate having an isocyanate content of at least 10% by weight,
b) an isocyanate reactive component comprising one or more polyether polyols having from 2 to 6 hydroxyl groups and a number average molecular weight of at least 250 to 8,000 and 0 to 10% by weight, based on total weight of b), of a low molecular weight diol or triol having an equivalent weight of 31 to 99, and
c) an organometallic catalyst, and (2) allowing the polyurethane composition to cure.

16. The process of claim 15, wherein two or more polyurethane geotextile composite liners are placed over each other.

17. The process of claim 15, wherein the unfilled polyurethane composition is applied by spraying it onto the geotextile.

18. A process for forming a polyurethane geotextile composite comprising applying an unfilled polyurethane composition on a concrete surface of a ditch or canal by spraying and contacting a geotextile with the polyurethane composition in a manner such that a polyurethane geotextile composite can be formed upon curing of the polyurethane and allowing the polyurethane to cure, the unfilled polyurethane composition comprising a reaction product of:
a) a liquid polyisocyanate having an isocyanate group content of at least 10% by weight;
b) an isocyanate reactive component comprising one or more polyether polyols having from 2-6 hydroxyl groups and a number average molecular weight of at least 250 to about 8,000 and 0-10% by weight, based on total weight of b), of a low molecular weight diol or triol having a hydroxy equivalent weights of from about 31 to 99, and
c) an organometallic catalyst.

19. An improved polyurethane geotextile composite suitable for use as a liner for canals and ditches comprising a geotextile impregnated with an unfilled polyurethane composition, the unfilled polyurethane composition comprising a reaction product of:
a) a liquid polyisocyanate having an isocyanate content of at least 10% by weight,
b) a polyol mixture comprising:
i) from 5 to 15 parts by weight of a propylene oxide adduct of an amine containing starting component, which adduct has a molecular weight of up to 1000,
ii) a propylene oxide adducts of a low molecular weight organic compound having from 3 to 6 OH groups which adduct has a molecular weight of no more than 1000,
iii) a propylene oxide adduct of a low molecular weight diol which adduct has a molecular weight of no more than 3000, and
c) from 0.0001 to 0.05 parts by weight per hundred parts by weight of the polyol mixture of a tin catalyst.

20. The composite of claim 19 in which adduct i) of the polyol mixture has a molecular weight of from 400 to 600, adduct ii) of the polyol mixture has a molecular weight of from 600 to 800 and adduct iii) has a molecular weight of from 1,500 to 2,500.

21. A canal or ditch lined with an improved polyurethane geotextile composite which has been produced by dispensing an unfilled polyurethane composition onto a geotextile, laying the polyurethane geotextile onto a surface of a canal or ditch before the polyurethane composition has fully cured, conforming the polyurethane geotextile to the shape of the surface of the canal or ditch, and allowing the polyurethane composite to fully cure to form a polyurethane geotextile composite liner, the unfilled polyurethane composition comprising a reaction product of:
a) a liquid polyisocyanate having an isocyanate content of at least 10% by weight, p1 b) an isocyanate reactive component comprising one or more polyether polyols having from 2 to 6 hydroxyl groups and a number average molecular weight of at least 250 to 8,000 and 0 to 10% by weight, based on total weight of b), a low molecular weight diol or triol having an equivalent weight of from 31 to 99, and
c) an organometallic catalyst.
